(19) United States
(12) Patent Application Publication
(10) Pub. No.: US 2009/0178201 A1
(43) Pub. Date: Jul. 16, 2009

(54) Adjustable Bed Having Movable Lumbar Support

(75) Inventors: Leonard D. Lujan, Carthage, MO (US); William R. Rohr, Joplin, MO (US)

Correspondence Address: WOOD, HERRON & EVANS, LLP, 2700 CAREW TOWER, 441 VINE STREET, CINCINNATI, OH, 45202, US

(73) Assignee: L&P PROPERTY MANAGEMENT COMPANY, South Gate, CA (US)

(21) Appl. No.: 12/014,401

(22) Filed: Jan. 15, 2008

(51) Int. Cl. A61G 7/015; A47C 20/00

(52) U.S. Cl. 5/618; 5/630

(57) ABSTRACT

An adjustable bed includes an articulated deck comprising head, seat, leg and foot deck boards hingedly joined together and supported from a frame movable relative to a stationary base. An lumbar support assembly, including a linear actuator operatively coupled to one of the deck boards, includes a plate which may be raised or lowered through an opening the articulated deck.

### FIELD OF THE INVENTION

This invention relates generally to adjustable beds and, more particularly, to an adjustable bed having a motorized lumbar support assembly.

### BACKGROUND OF THE INVENTION

A well known type of bedding product comprises a motorized adjustable bed in which an articulated frame supports a mattress. These motorized adjustable beds have traditionally been used in hospitals but more and more are being installed and used in residential homes. Motorized adjustable beds have conventionally had an upper body support movable between an inclined position in which it supports the patient in a sitting position and a prone position in which the patient lies down in a generally horizontal position. In addition, a leg support is movable between positions and may be adjusted to a desired degree of inclination. An actuating mechanism, commonly two or more electric motors, raises and lowers the head and leg supports of the articulated bed frame. U.S. Pat. No. 5,640,730 discloses such an adjustable bed.

U.S. Pat. Nos. 6,499,162 and 6,640,365 disclose adjustable beds comprising a plurality of bed plates pivotally secured together for supporting a mattress. Connecting elements or links pivotally connect a base to the bed plates. A movable member slides along the base and is activated by a piston movable from inside a cylinder secured to the base. Activation of a power source such as an electric motor causes movement of the bed plates via movement of the sliding member.

Lower back pain and related health issues are common today. When lying in bed, people often put pillows under their back to provide additional support to the lumbar or lower back portion of one's spine. This may be particularly problematic with pregnant women.

It has therefore been an objective of this invention to provide an adjustable bed with a lumbar support assembly. To that end, and in accordance with this invention, a motorized actuator may be activated to raise a portion of a mattress via a lumbar support plate, thereby enabling the user of the adjustable bed to have increased lower back support while in bed whether the adjustable bed is fully inclined or horizontal.

### SUMMARY OF THE INVENTION

This invention comprises an adjustable bed having an adjustable deck for supporting a mattress. The adjustable bed is preferably powered by an electric motor driven linear actuator assembly. However, any other drive assembly, such as a conventional electrical motor driven screw and nut actuator system may be used in accordance with the present invention.

The adjustable bed, in one embodiment, comprises a generally rectangular stationary base comprising a pair of opposed side rails, a head end rail and a foot end rail located at the head and foot ends of the adjustable bed, respectively. Supports extending downwardly from the head and foot end rails support the base a fixed distance above the floor or supporting surface. Although legs are preferable, other types of supports may be used to raise and/or maintain the stationary base above the supporting surface.

Each of the side rails of the base has a channel built therein. More particularly, each of the side rails of the stationary base has a “C-shaped” cross-sectional configuration which defines the channel.

This adjustable bed further comprises a frame spaced above the stationary base and movable relative to the stationary base. Such an adjustable bed is known in the art as a “wall hugger” adjustable bed. The frame includes a pair of side assemblies joined by transversely extending cross members. Each of the side assemblies of the frame comprises a generally “L-shaped” member comprising a vertically oriented leg portion and a horizontally oriented side portion. A support leg is secured to the horizontally oriented side portion of the generally “L-shaped” member so each side assemblies has two legs. In combination, each side assembly of the movable frame has two legs, each having a roller rotatably secured to the leg at the bottom thereof which travels or moves in one of the channels of one of the side rails of the stationary base.

The adjustable bed further comprises an articulated deck for supporting a mattress or similar product. The articulated deck comprises a head deck board, a seat deck board fixedly secured to the movable frame, a leg deck board and a foot deck board hingedly joined to each other. The articulated deck is movable between a horizontal position in which all of the deck boards are horizontal and coplanar and a fully inclined position in which the head, leg and foot boards are inclined and the seat deck board remains in its horizontal position and fixed to the movable frame.

The adjustable bed further comprises a pair of foot links which connect the movable frame to the foot deck board. Each foot link has an adjustable length but may be manually set to have a predetermined, fixed length. Each foot link is pivotally secured to one of the side rails of the movable frame at one end and pivotally secured to a bracket fixedly secured to the foot deck board at its other end.

A linear actuator assembly is operatively coupled to the movable frame of the adjustable bed and moves with the frame. The linear actuator assembly functions to move the articulated deck between a first horizontal position in which all of the deck boards are co-planar in a horizontal position and a second fully inclined position in which the head deck board is inclined, the seat deck board generally horizontal, the leg and foot deck boards inclined.

The linear actuator assembly comprises at least one linear actuator. In one embodiment, two linear actuators are used, each one being secured at one end to one of the cross members of the frame and secured at the other end to link arms extending outwardly from a pivotal or rotatable torque tube. Such a drive mechanism is disclosed in pending U.S. patent application Ser. No. 11/870,148 which is fully incorporated herein. The first and second torque tubes are part of the movable frame, are pivotally secured to brackets secured to side assemblies of the movable frame and extend between the side assemblies of the frame.

A pair of operating arms are welded or otherwise secured to each torque tube, each of the operating arms having a roller at the end thereof for engaging the articulated deck. The operating arms welded or otherwise secured to the first torque tube have rollers at the ends thereof which contact the head deck board of the articulated deck and upon the first torque tube rotating or pivoting raise the head deck board from its first horizontal position to its second inclined position. Likewise, operating arms welded or otherwise secured to the second torque tube have rollers at the ends thereof which contact the leg deck board of the articulated deck and upon the second torque tube rotating or pivoting raise the leg deck board from its first horizontal position to its second inclined position.

In operation, starting from the first position of the adjustable bed in which the articulated deck is generally horizontal, an operator activates the motorized actuator assembly in any known manner. The electric motors or linear actuators rotate or pivot the torque tubes which, in turn, causes the operating arms extending outwardly from the torque tubes to rotate or pivot about a horizontal axis. Movement of the operating arms causes the rollers at the ends of the operating arms to contact the head and leg deck boards to move the head and leg deck boards from their first horizontal position to their second inclined position. As the head deck board inclines, the seat deck board moves horizontally towards the head end of the bed with the frame in what is known in the industry as a wall hugger motion. As the seat deck board moves towards the head end of the bed, the leg deck board moves from its first horizontal position to its second inclined position. This movement of the leg deck board causes the foot deck board to incline, its foot edge moving towards the head end of the bed as the foot links pivot about horizontal pivot axes.

The configuration of this embodiment of adjustable bed allows a user to move an upper frame of the adjustable bed relative to a stationary base using rollers traveling in channels in the base. The adjustable bed enables the deck to move between a first horizontal or prone position to a second inclined position with the assistance of the motorized actuator assembly of the articulated bed.

The adjustable bed further comprises a lumbar support assembly coupled to the seat deck board for raising and lowering a lumbar support plate through an opening in the articulated deck of the adjustable bed. The lumbar support assembly includes a d.c. linear actuator which is operatively coupled to the seat deck board with support brackets and powers a movable carriage which raises and lowers a lumbar support subassembly. The lumbar support subassembly comprises a pair of lift arms, one of the lift arms being secured to the movable carriage of the linear actuator. The lumbar support subassembly further comprises a lumbar torque tube extending between the lift arms and a lumbar plate also extending between the lift arms. The lumbar support assembly may further comprise a vibration motor secured to the lumbar plate.

In alternative embodiments of adjustable beds, such as non wall hugger adjustable beds in which the upper carriage or frame remains fixed relative to a stationary base, the lumbar support assembly of the present invention may be incorporated.

These and other objects and advantages of the present invention will be more readily apparent from the following drawings.

### BRIEF DESCRIPTION OF THE DRAWINGS

FIG. 1 is a bottom perspective view of an adjustable bed made in accordance with this invention in a fully inclined position supporting a mattress shown in phantom;

FIG. 2 is a top perspective view of the adjustable bed of FIG. 1 without the mattress showing the lumbar support in a raised position.

FIG. 2A is a top perspective view of the adjustable bed of FIG. 1 without the mattress showing the lumbar support in a lowered position.

FIG. 3 is a bottom perspective view of the adjustable bed of FIG. 1 without the mattress in a horizontal position showing the lumbar support in a raised position.

FIG. 3A is a bottom perspective view of the adjustable bed of FIG. 1 without the mattress in a horizontal position showing the lumbar support in a lowered position.

FIG. 4 is a side elevational view of the adjustable bed of FIG. 1 without the mattress in a horizontal position showing the lumbar support in a raised position;

FIG. 4A is a side elevational view of the adjustable bed of FIG. 1 without the mattress in a horizontal position showing the lumbar support in a lowered position;

FIG. 5 is a side elevational view, partially in cross section, of the adjustable bed of FIG. 1 without the mattress in a fully inclined position showing the lumbar support in a raised position.

FIG. 6 is a perspective view showing the lumbar support assembly;

FIG. 7 is bottom perspective view of an alternative embodiment of adjustable bed in a fully inclined position supporting a mattress shown in phantom; and

FIG. 8 is a side elevational view of the adjustable bed of FIG. 7 without the mattress in a horizontal position showing the lumbar support in a raised position.

### DETAILED DESCRIPTION OF THE DRAWINGS

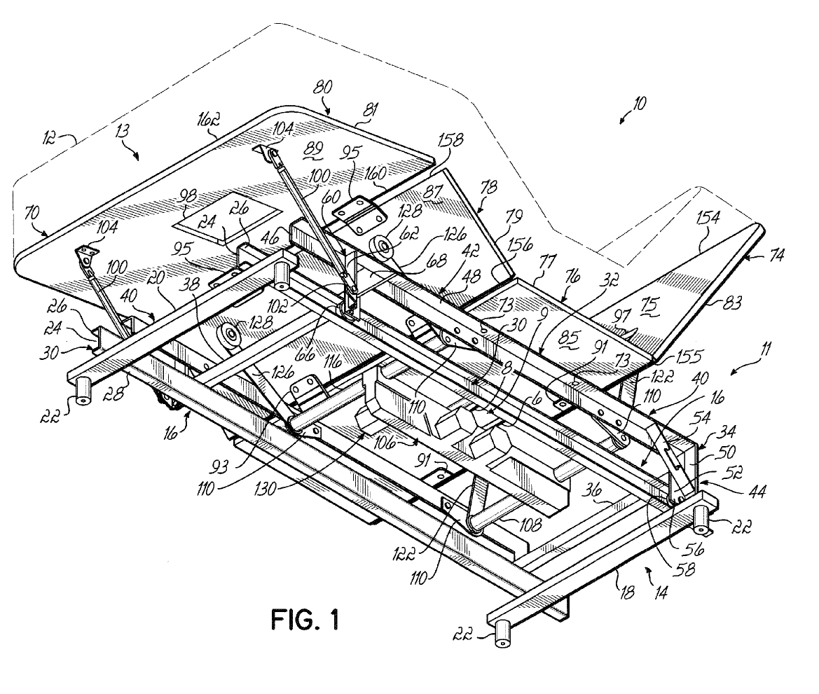

Referring to the drawings, and particularly to FIG. 1, there is illustrated an adjustable bed 10 including a mattress 12. The adjustable bed 10 may be used to support any type of mattress including an air mattress, a coil spring mattress or any other type of mattress. The mattress 12 does not form a part of the present invention.

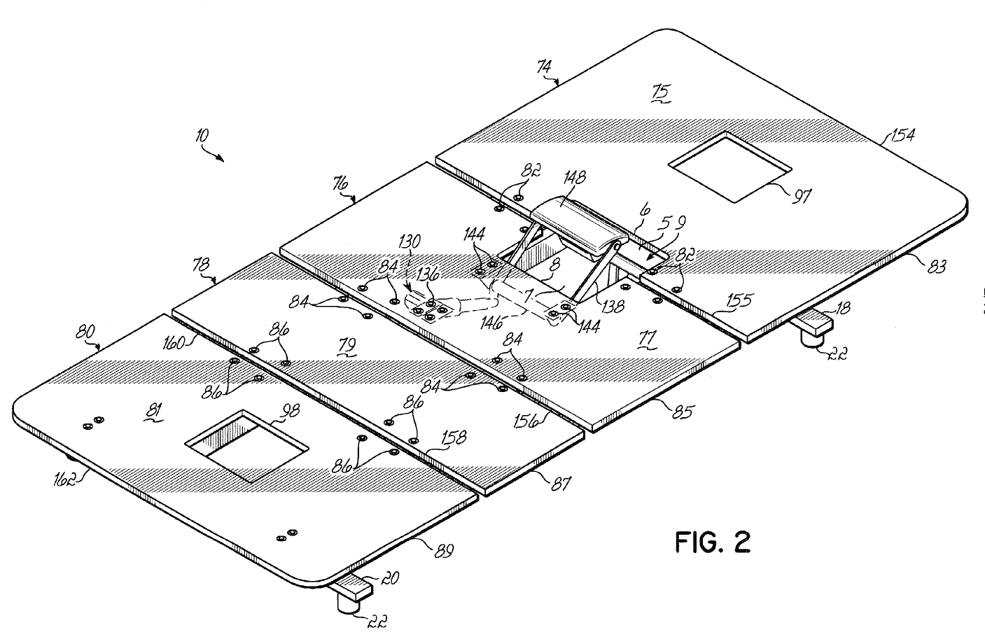

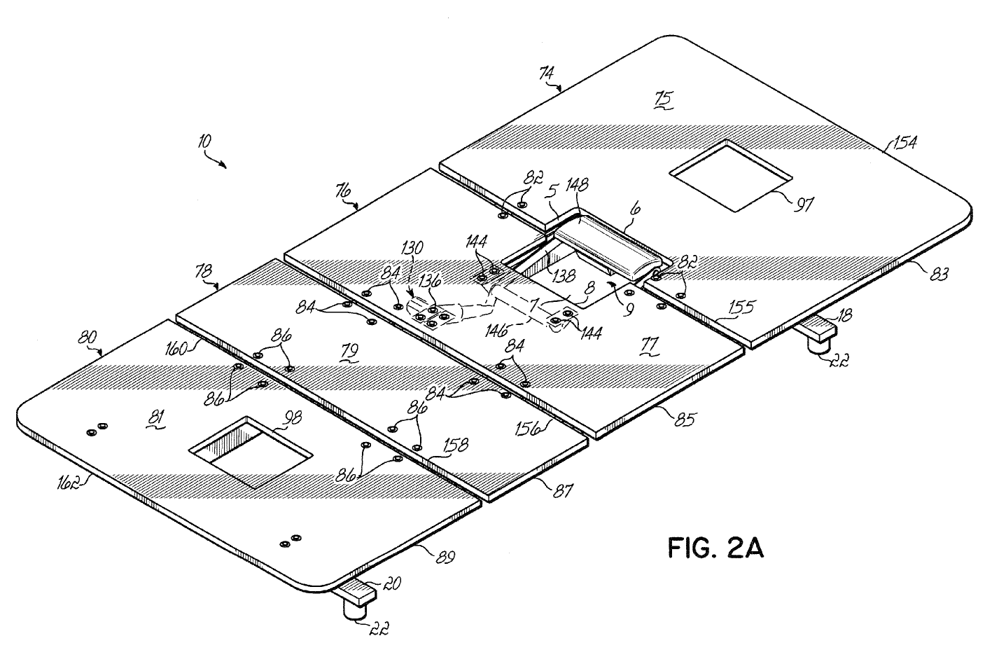

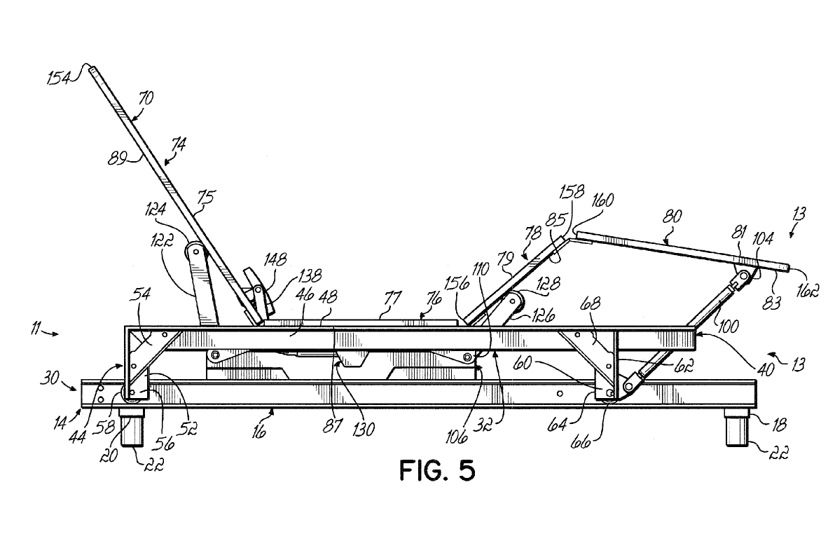

The adjustable bed 10 has a head end 11 and a foot end 13. The adjustable bed 10 is movable between a first horizontal position shown in FIGS. 2, 2A, 3, 3A, 4 and 4A and a fully inclined position as shown in FIGS. 1 and 5. Typically, an operator or user sleeps with the adjustable bed in its first horizontal position and reads or watches television with the adjustable bed in its fully inclined position. However, the adjustable bed 10 may assume any intermediate position between the extreme positions illustrated and maintained in such a position.

The adjustable bed 10 comprises a stationary generally rectangular base 14 comprising a pair of opposed side rails 16, a head end rail 18, a foot end rail 20 and four legs 22 supporting the base 14 a fixed distance about a floor or supporting surface (not shown). The head and foot end rails 18, 20, respectively, each are secured to each side rail 16 and extend therebetween. The head and foot end rails 18, 20, respectively, are illustrated being rectangular in cross-section. However, they may be any desired size or shape, hollow or solid. The legs 22 are shown secured and extending downwardly from the head and foot end rails 18, 20, respectively, but may be secured to the side rails 16 if desired. Although a cylindrical shaped leg 22 is illustrated, any configuration or length of leg or similar support may be used.

As shown in FIG. 1, each of the side rails 16 of the base 14 has a generally C-shaped cross-sectional configuration including a vertically oriented side portion 24, a horizontally oriented top portion 26 extending outwardly from the upper edge of the side portion 24 and a horizontally oriented bottom portion 28 extending outwardly from the lower edge of the side portion 24. The side, top and bottom portions, 24, 26 and 28, respectively, define an outwardly facing channel 30 in each side rail 16 of the base 14. Although each side rail 16 is illustrated having a generally C-shaped cross-sectional configuration along its entire length, any desired configuration or length of side rail may be used in the base. For example, the channels may be shaped differently than those illustrated.

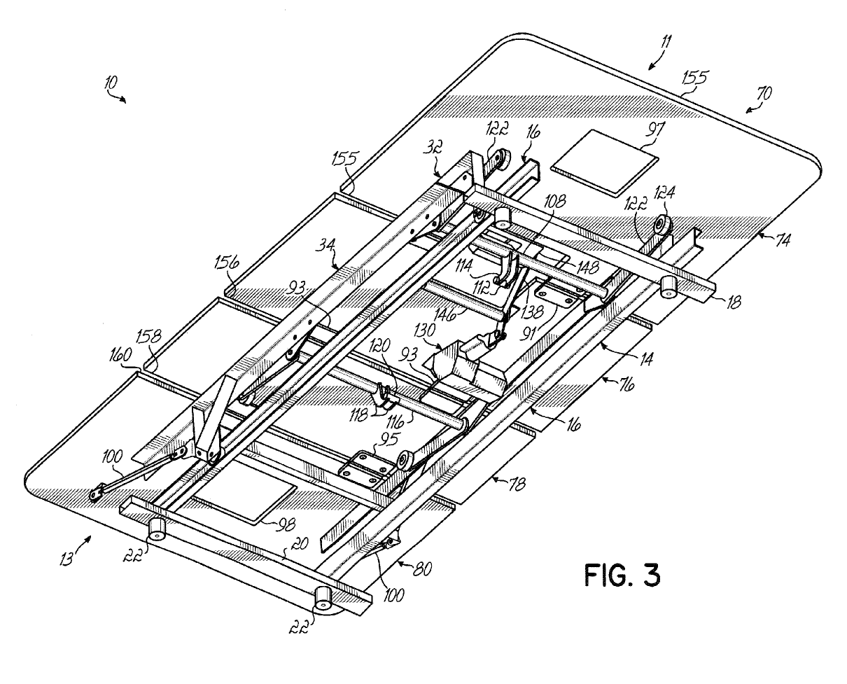

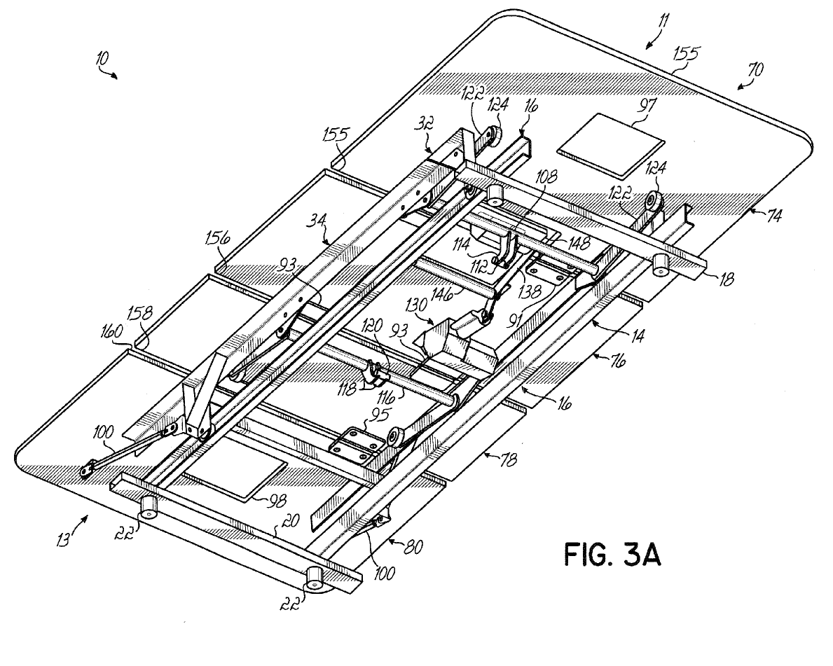

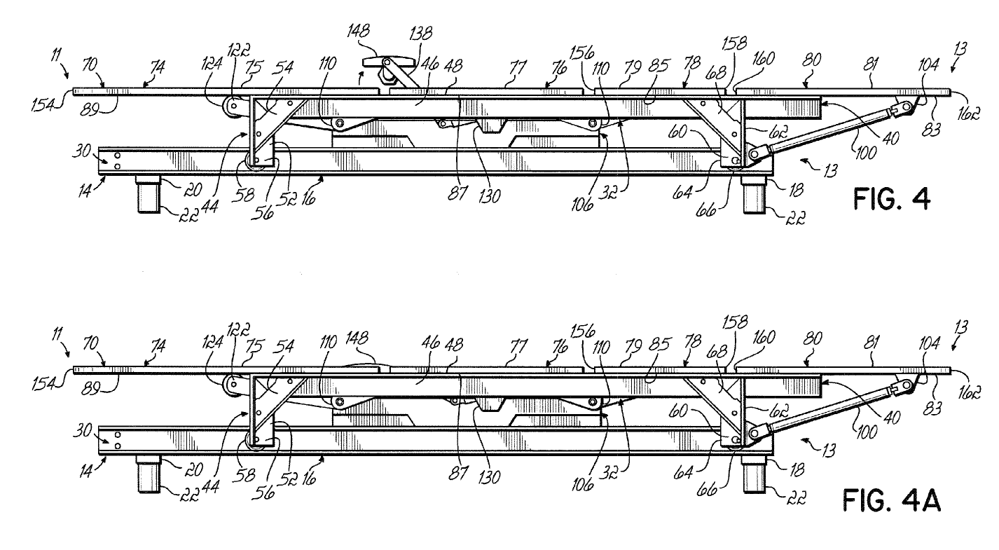

The adjustable bed 10 further comprises a frame 32 movable relative to the stationary base 14. The frame 32 is movable between a first position shown in FIGS. 3, 3A, 4 and 4A when the adjustable bed 10 is in its first horizontal position and a second position shown in FIGS. 1 and 5 when the adjustable bed 10 is in its fully inclined position. In its first position shown in FIGS. 3, 3A, 4 and 4A, the frame 32 is located proximate the foot end 13 of the bed 10 (to the right as shown in FIGS. 3, 3A, 4 and 4A). In its second position shown in FIG. 5, the frame 32 is located proximate the head end 11 of the bed (to the left as shown in FIG. 5).

As shown in the drawings, the movable frame 32 comprises a pair of side assemblies 34 connected by front and rear cross members 36, 38, respectively. Each of the front and rear cross members 36, 38, respectively, are joined to each side assembly 34 and extends therebetween. The front and rear cross members 36, 38, respectively, of the movable frame 32 are illustrated being rectangular in cross-section. However, they may be any desired size or shape, hollow or solid.

Each of the side assemblies 34 of the movable frame 32 comprises a generally “L-shaped” member 40 having a horizontal portion 42 and a vertical leg portion 44 at the head end 11 of the adjustable bed 10 extending downwardly from the horizontal portion 42 of the generally “L-shaped” member 40. The horizontal portion 42 has a vertical flange 46 and a horizontal flange 48 while the vertical leg portion 44 has a first flange 50, a continuation of the horizontal flange 48 and a second flange 52, a continuation of the vertical flange 46. Thus, each portion 42, 44 of each generally “L-shaped” member 40 has an “L-shaped” cross sectional configuration.

A front brace 54 extends between the horizontal portion 42 and the vertical leg portion 44 of the generally “L-shaped” member 40. The brace 54 is riveted, welded or otherwise secured to the vertical flange 46 of the horizontal portion 42 and the second flange 52 of the leg portion 44 of the generally “L-shaped” member 40. Although one configuration of front brace 54 is illustrated, other configurations or styles of braces may be used.

For purposes of this document, the vertical leg portion 44 of each generally “L-shaped” member 40 of the movable frame 32 may be referred to as a front leg 56 which has a front roller 58 rotatably secured at the bottom thereof, each front roller 58 being sized and adapted to travel inside the channel 30 of one of the side rails 16 of the stationary base 14. The front roller 58 is rotatably secured to the second flange 52 of the front leg 56.

Each of the side assemblies 34 further comprises a support or rear leg 60 having a first flange 62 and a second flange 64 at right angles or orthogonal to each other. Thus, the support or rear leg 60 has a cross sectional configuration which is generally “L-shaped.” The first flange 62 of the rear leg 60 is parallel the first flange 50 of the front leg 56 while the second flange 64 of the rear leg 60 is parallel the second flange 52 of the front leg 56. A rear roller 66 is rotatably secured to the second flange 64 of the rear leg 60 of each side assembly 34 of the movable frame 32. Each rear roller 66 is sized and adapted to travel inside the channel 30 of one of the side rails 16 of the stationary base 14.

A rear brace 68 extends between the horizontal portion 42 of the generally “L-shaped” member 40 and the rear leg 60. The rear brace 68 is riveted, welded or otherwise secured to the vertical flange 46 of the horizontal portion 42 of the generally “L-shaped” member 40 and the second flange 64 of the rear leg 60 of each side assembly 34. Although one configuration of rear brace 68 is illustrated, other braces may be used.

The articulated deck 70 comprises a head deck board 74, a seat deck board 76, a leg deck board 78 and a foot deck board 80. Each of the deck boards is preferably the same width but any two deck boards may be different widths, if desired. Deck boards 74, 76, 78 and 80 have upper surfaces 75, 77, 79 and 81, respectively, and lower surfaces 83, 85, 87 and 89, respectively. A portion of the articulated deck 70, the seat deck board 76, is operatively coupled to the movable frame 32 with fasteners 73.

As best illustrated in FIGS. 2 and 2A, the head deck board 74 has a generally rectangular cutout portion 5 defined along edge 6. Similarly, the seat deck board 76 has a generally rectangular cutout portion 7 defined along edge 8. The combined cutout portions 5 and 7 define a generally rectangular opening 9 adapted to allow a lumbar support to pass therethrough as shown in FIG. 2 and described below.

As best illustrated in FIGS. 1, 2 and 2A, the head deck board 74 is hingedly secured to the seat deck board 76 with hinges 91 secured to the lower surfaces 83, 85 of the head and seat deck boards 74, 76, respectively, with fasteners 82. Similarly, seat deck board 76 is hingedly secured to leg deck board 78 with hinges 93 secured to the lower surfaces 85, 87 of the seat and leg deck boards 76, 78, respectively with fasteners 84. Leg deck board 78 is hingedly secured to foot deck board 80 with hinges 95 secured to the lower surfaces 87, 89 of the leg and foot deck boards 78, 80, respectively with fasteners 86. Although, two hinges are shown securing adjacent deck boards, any number of hinges may be used including one continuous hinge.

The deck boards 74, 76, 78 and 80 are preferably made of plywood, but may be made of plastic, oriented strand board or any other material.

As illustrated in FIG. 2, the head deck board 74 has a rectangular hole 97 therein which may be used to mount a massage unit (not shown) as is common in the industry. Similarly, as illustrated in FIGS. 1 and 2, the foot deck board 80 has a rectangular hole 98 therein which may be used to mount a massage unit (not shown) as is common in the industry. If desired, one or both of these holes 97, 98 may be omitted.

As illustrated in FIG. 1, the seat deck board 76 is fixedly secured to the movable frame 32 with fasteners 73. More particularly, the fasteners 73 pass through holes in the horizontal flange 48 of the horizontal portion 42 of each side assembly 34 of the movable frame 32 and into the material of the seat deck board 76. Thus, the seat deck board 76 remains flat and fixed in the same location relative to the movable frame 32. When the movable frame 32 moves, the seat deck board 76 moves with it.

The adjustable bed 10 further comprises two foot links 100 or connectors, each of the same fixed length. Each of the foot links 100 is pivotally secured at a lower end to one of the rear legs 60 of the side assemblies 34 of the movable frame 32 with fastener 102 so that each pivots about a horizontal pivot axis. See FIG. 1. Each foot link 100 is pivotally secured at its upper end to a bracket 104 fixed to the lower surface 89 of the foot deck board 80.

The articulated deck 70 is moved by a motorized linear actuator assembly 106 between a first position shown in FIGS. 3, 3A, 4 and 4A in which the deck boards 74, 76, 78 and 80 are generally co-planar in a horizontal position or orientation and a second position shown in FIGS. 1 and 5. In the second position, the head deck board 74 is inclined, the seat deck board 76 is substantially horizontal and fixed to the movable frame 32, the leg deck board 78 inclined and the foot deck board 80 slightly inclined.

The motorized linear actuator assembly 106 is part of the movable frame 32 and moves with the movable frame 32 relative to the stationary base 14. The motorized linear actuator assembly 106 comprises a pair of linear actuators each driven by a motor. One of the linear actuators of motorized linear actuator assembly 106 is adapted to pivot or rotate a first torque tube 108 which comprises part of the movable frame 32 and extends between brackets 110 fixedly secured to the side assemblies 34 of the movable frame 32. Each bracket 110 is fixed to the vertical flange 46 of the horizontal portion 42 of the side assembly 34. See FIG. 1.

The motorized linear actuator assembly 106 further comprises a pair of linear actuators (not shown), one of which is receivable engages a pin 112 extending between a pair of spaced link arms 114 (see FIGS. 3 and 3A). Each link arm 114 is welded or secured at its upper end to first rotatable or pivotal torque tube 108.

Similarly, a second pivotal or rotatable torque tube 116 comprises part of the movable frame 32 and extends between brackets 110 fixedly secured to the side assemblies 34 of the movable frame 32 and more particularly to the vertical flange 46 of the horizontal portion 42 of the side assembly 34. See FIG. 1. As shown in FIGS. 3 and 3A, a pair of spaced link arms 118 are welded or secured at their upper ends to second rotatable or pivotal torque tube 116. A pin 120 extends between link arms 118. The second linear actuator of motorized linear actuator assembly 106 engages the pin 120 and upon actuation or extension rotates the second torque tube 116 located towards the foot end 13 of the bed 10. The first and second torque tubes 108, 116 comprise part of the movable frame 32, move with the movable frame 32 and are pivoted or rotated by the motorized linear actuator assembly 106 which also comprises part of the movable frame 32 and moves with it.

As best shown in FIG. 5, the first torque tube 108 has a pair of spaced operating arms 122 extending upwardly therefrom, each arm 122 being a fixed length and having a roller 124 at the end thereof for engaging the lower surface 83 of the head deck board 74. Each operating arm 122 is welded or otherwise fixedly secured to the first torque tube 108 at its lower end.

Likewise, the second torque tube 116 has a pair of spaced operating arms 126 extending upwardly therefrom, each arm 126 being a fixed length and having a roller 128 at the end thereof for engaging the lower surface 87 of the leg deck board 78. See FIG. 5. Each operating arm 126 is welded or otherwise fixedly secured to the second torque tube 116 at its lower end.

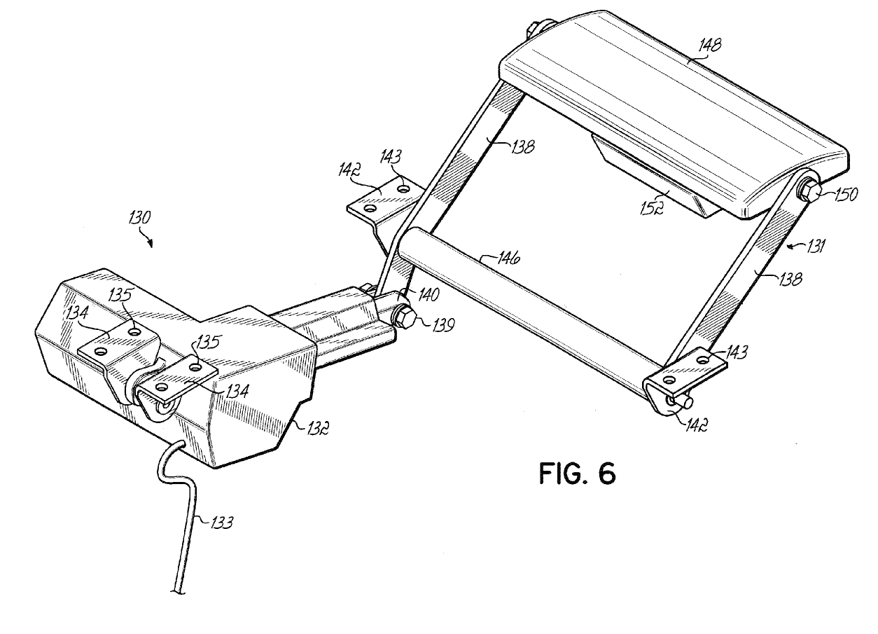

As best illustrated in FIG. 6, the adjustable bed 10 further comprises a lumbar support assembly 130 for supporting one's lower back. The lumbar support assembly 130 includes a direct current or d.c. linear actuator 132 which is supported by the seat deck board 76 as shown in FIGS. 2 and 2A and is powered by a power source (not shown) via a cord 133. A pair of support brackets 134 each have holes 135 and are part of the linear actuator 132. The support brackets 134 are adapted to receive fasteners 136 passing through the seat deck board 76 as shown in FIGS. 2 and 2A for supporting the linear actuator 132. Although any type of linear actuator may be used, one which has proven satisfactory is a motorized linear actuator available from Okin America, LLC of Shannon, Miss. sold under Part Number 1.01.000.663.30.

The lumbar support assembly 130 further comprises a subassembly 131 coupled to the linear actuator 132 with a fastener or bolt 139. The subassembly 131 includes a pair of lift arms 138, one of the lift arms 138 being secured at its lower end to a movable carriage 140 of the linear actuator 132. A pair of support brackets 142 having holes 143 adapted to receive fasteners 144 are used to secure and support the lumbar support subassembly 131 by the seat deck board 76 as shown in FIGS. 2 and 2A. The lumbar support subassembly 131 further comprises a pivotal or rotatable torque tube 146 extending between the lift arms 138 as shown in FIG. 6. Additionally, the lumbar support subassembly 131 further comprises a lumbar plate 148 extending between the lift arms 138 and secured to the lift arms with fasteners 150 as shown in FIG. 6.

As shown in FIG. 6, the lumbar support assembly 130 may further comprise a motorized vibrator 152 secured to the underside of the lumbar plate 148. Although any type of motorized vibrator may be used, one which has proven satisfactory is a d.c. motorized vibrator available from Hankscraft Incorporated of Reedsburg, Wis. sold under Part Number 25888.

Via activation of the linear actuator 132, the movable carriage 140 extends outwardly as shown in FIG. 3, thereby raising the lumbar support subassembly 131 and particularly the lumbar plate 148 from its lower position shown in FIGS. 2A, 3A and 4A to its raised position shown in FIGS. 2, 3, 4 and 5. In its lowered position, the lumbar plate 148 is generally coplanar with the upper surfaces of the deck boards as shown in FIG. 4A. In its raised position, the lumbar plate 148 is above the upper surfaces of the deck boards as shown in FIG. 4 and thus pushes the mattress 12 upwardly in the lumbar or lower back region of the user.

In operation, starting from the first position of the adjustable bed 10 shown in FIGS. 3, 3A, 4 and 4A in which the articulated deck 70 is generally horizontal, an operator (not shown) activates the motorized linear actuator assembly 106 with or without a remote (not shown). Activation of the motorized linear actuator assembly 106 rotates or pivots torque tubes 108, 116. Rotation or pivoting the torque tubes 108, 116 causes the operating arms 122, 126 to rotate or pivot about a horizontal axis parallel the torque tubes 108, 116. The rollers 124, 128 located at the upper ends of the operating arms 122, 126 contact the head and leg deck boards 74, 78, respectively, and move them from their first horizontal position shown in FIGS. 3, 3A, 4 and 4A to their second fully inclined position shown in FIG. 5 in which the head edge 154 of the head deck board 74 is above the rear edge 155 of the head deck board 74.

As the head deck board 74 inclines, the seat deck board 76 and movable frame 32 move towards the head end 11 of the bed (to the left in FIGS. 4, 4A and 5), causing or pulling the leg deck board 78 horizontally towards the head end 11 of the bed. The leg deck board 78 also moves towards the head end 11 of the bed 10, from its first horizontal position shown in FIGS. 3 and 4 to its second fully inclined position shown in FIG. 5. In this fully inclined position, the front edge 156 of the leg deck board 78 is lower than the rear edge 158 of the leg deck board 78. This movement of the leg deck board 78 causes or pulls the foot deck board 80 towards the head end 11 of the bed as the foot links 100 are pivoted about horizontal pivot axes in a counterclockwise direction as viewed in FIGS. 4 and 5. In its fully inclined position shown in FIG. 5, the front edge 160 of the foot deck board 80 is higher than the rear edge 162 of the foot deck board 80.

As desired, the adjustable bed 10 may be moved from its fully inclined position shown in FIG. 5 (in which the front edge 154 of the head deck board 74 is above the rear edge 155 of the head deck board 74) back to its horizontal position shown in FIG. 4 via use of the motorized linear actuator assembly 106. Regardless of the position of the adjustable bed 10, the lumbar support assembly 130 may be activated to raise the lumbar plate 148. For example, FIG. 5 shows the lumbar support subassembly 131 in a raised position when the adjustable bed 10 is in a fully inclined position.

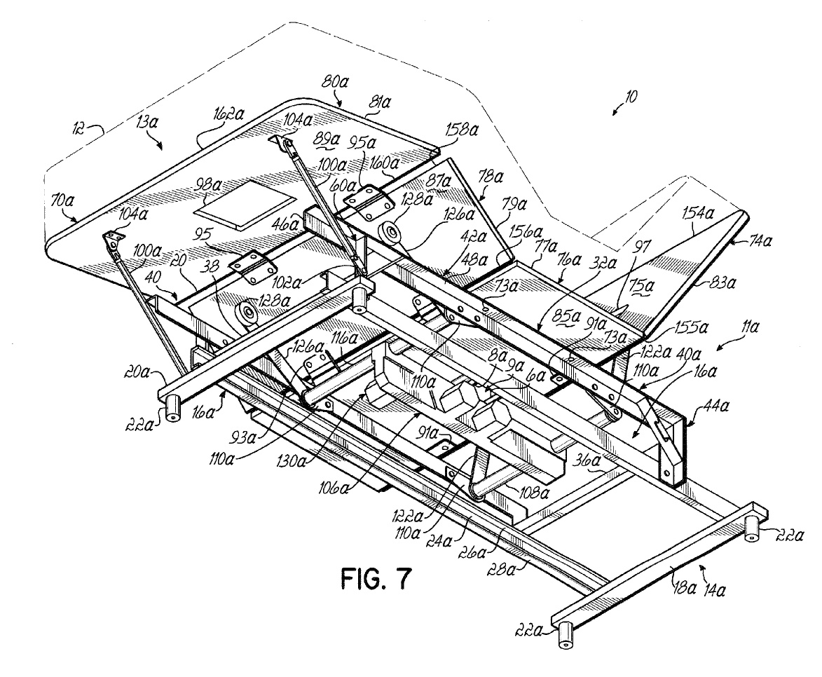

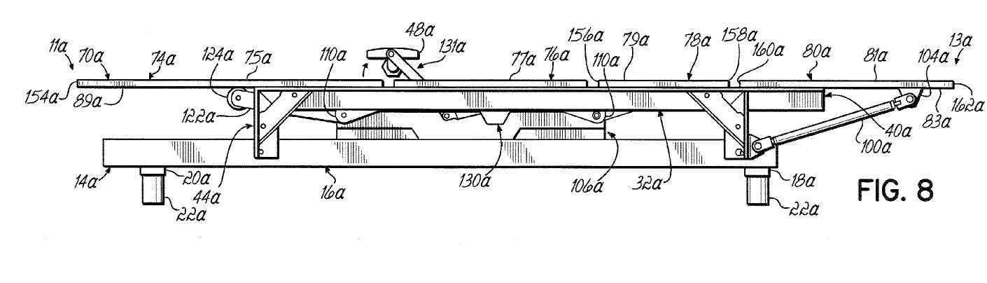

The lumbar support assembly 130 may be used with any adjustable bed. FIGS. 7 and 8 illustrate an alternative embodiment of adjustable bed 10a having the lumbar support assembly 130. This adjustable bed 10a is not considered a wall hugger adjustable bed because the frame does not move relative to the base. For purposes of simplicity, like parts are identified with like numbers but an “a” designation in the description of this embodiment. The adjustable bed 10a has a head end 11a and a foot end 13a. The adjustable bed 10a is movable between a first horizontal position shown in FIG. 8 and a fully inclined position shown in FIG. 7. This adjustable bed 10a is equipped with a lumbar support assembly 130 as described above and illustrated in FIGS. 1-6.

The adjustable bed 10a comprises a stationary generally rectangular base 14a, like base 14, comprising a pair of opposed side rails 16a, a head end rail 18a, a foot end rail 20a and four legs 22a supporting the base 14a a fixed distance about a floor or supporting surface (not shown). The head and foot end rails 18a, 20a, respectively, each are secured to each side rail 16a and extend therebetween. The head and foot end rails 18a, 20a, respectively, are illustrated being rectangular in cross-section. However, they may be any desired size or shape, hollow or solid. The legs 22a are shown secured and extending downwardly from the head and foot end rails 18a, 20a, respectively, but may be secured to the side rails 16a. Although a cylindrical shaped leg 22a is illustrated, any configuration or length of leg or similar support may be used.

As shown in FIG. 7, each of the side rails 16a of the base 14a has a generally C-shaped cross-sectional configuration including a vertically oriented side portion 24a, a horizontally oriented top portion 26a extending outwardly from the upper edge of the side portion 24a and a horizontally oriented bottom portion 28a extending outwardly from the lower edge of the side portion 24a. The side, top and bottom portions, 24a, 26a and 28a, respectively, define an inwardly facing channel 30a in each side rail 16a (opposite the direction of the channels 30). Although each side rail 16a is illustrated having a generally C-shaped cross-sectional configuration along its entire length, any desired configuration or length of side rail may be used in the base. For example, the channels may be shaped differently than those illustrated.

The adjustable bed 10a further comprises an upper carriage or frame 32a welded or otherwise fixed relative to the stationary base 14a. The frame 32a comprises a pair of side assemblies 34a identical to the side assemblies 34 of frame 32 described above.

An articulated deck 70a is operatively coupled to the frame 32a; more particularly seat deck board 76a of the articulated deck 70a is operatively coupled to the frame 32a with fasteners 73a. The articulated deck 70a comprises a head deck board 74a, a seat deck board 76a, a leg deck board 78a and a foot deck board 80a. Each of the deck boards is preferably the same width but any two deck boards may be different widths, if desired. Deck boards 74a, 76a, 78a and 80a have upper surfaces 75a, 77a, 79a and 81a, respectively, and lower surfaces 83a, 85a, 87a and 89a, respectively.

As illustrated in FIG. 7, the head deck board 74a is hingedly secured to the seat deck board 76a with hinges 91a as described above with respect to hinges 91. Similarly, seat deck board 76a is hingedly secured to leg deck board 78a with hinges 93a as described above with respect to hinges 93. Leg deck board 78a is hingedly secured to foot deck board 80a with hinges 95a as described above with respect to hinges 95. Although, two hinges are shown in FIG. 7 securing adjacent deck boards, any number of hinges may be used including one continuous hinge. The deck boards 74a, 76a, 78a and 80a are preferably made of plywood, but may be made of plastic, oriented strand board or any other material.

As illustrated in FIG. 7, the head deck board 74a may have a rectangular hole 97a therein which may be used to mount a massage unit (not shown) as is common in the industry. Similarly, as illustrated in FIG. 7, the foot deck board 80a may have a rectangular hole 98a therein which may be used to mount a massage unit (not shown) as is common in the industry.

As illustrated in FIG. 7, the seat deck board 76a is fixedly secured to the frame 32a with fasteners 73a. Thus, the seat deck board 76a remains flat and fixed in the same location relative to the frame 32a.

As illustrated in FIGS. 7 and 8, the head deck board 74a has a generally rectangular cutout portion 5a defined along edge 6a. Similarly, the seat deck board 76a has a generally rectangular cutout portion 7a defined along edge 8a. The combined cutout portions 5a and 7a define a generally rectangular opening 9a adapted to allow a lumbar support to pass therethrough as shown in FIG. 8.

The adjustable bed 10a further comprises two foot links 100a or connectors, each of the same fixed length, each pivotally secured at a lower end to one of the rear legs 60a of the side assemblies 34a of the frame 32a so that each pivots about a horizontal pivot axis. See FIG. 7. Each foot link 100a is pivotally secured at its upper end to a bracket 104a fixed to the lower surface 89a of the foot deck board 80a.

The articulated deck 70a is moved by a motorized linear actuator assembly 106 between a first position shown in FIG. 8 in which the deck boards 74a, 76a, 78a and 80a are generally co-planar in a horizontal position or orientation and a second position shown in FIG. 7. In the second position, the head deck board 74a is inclined, the seat deck board 76a is substantially horizontal and fixed to the frame 32a, the leg deck board 78a inclined and the foot deck board 80a slightly inclined as shown in FIG. 8.

The motorized linear actuator assembly 106a is secured to the movable frame 32. The motorized linear actuator assembly 106a is identical to motorized linear actuator assembly 106 described above.

A first pivotal or rotatable torque tube 108a and a second pivotal or rotatable torque tube 116 comprise part of the frame 32 and each extends between brackets 110 fixedly secured to the side assemblies 34 of the movable frame 32. The first and second torque tubes 108a, 116a are pivoted or rotated by the motorized linear actuator assembly 106a which also comprises part of the frame 32a.

As best shown in FIG. 7, the first torque tube 108a has a pair of spaced operating arms 122a extending upwardly therefrom, each arm 122a being a fixed length and having a roller 124a at the end thereof for engaging the lower surface 83a of the head deck board 74a. Each operating arm 122a is welded or otherwise fixedly secured to the first torque tube 108a at its lower end.

Likewise, the second torque tube 116a has a pair of spaced operating arms 126a extending upwardly therefrom, each arm 126a being a fixed length and having a roller 128a at the end thereof for engaging the lower surface 87a of the leg deck board 78a. See FIG. 7. Each operating arm 126a is welded or otherwise fixedly secured to the second torque tube 116a at its lower end.

In operation, starting from the first position of the adjustable bed 10a shown in FIG. 8 in which the articulated deck 70a is generally horizontal, an operator (not shown) activates the motorized linear actuator assembly 106a with or without a remote (not shown). Activation of the motorized linear actuator assembly 106a rotates or pivots torque tubes 108a, 116a. Rotation or pivoting the torque tubes 108a, 116a causes the operating arms 122a, 126a to rotate or pivot about a horizontal axis parallel the torque tubes 108a, 116a. The rollers 124a, 128a located at the upper ends of the operating arms 122a, 126a contact the head and leg deck boards 74a, 78a, respectively, and move them from their first horizontal position shown in FIG. 8 to their second fully inclined position shown in FIG. 7 in which the head edge 154a of the head deck board 74a is above the rear edge 155a of the head deck board 74a.

As the head deck board 74a inclines, the seat deck board 76a and movable frame 32a remain stationary. The leg deck board 78a also moves from its first horizontal position shown in FIG. 8 to its second fully inclined position shown in FIG. 7. In this fully inclined position, the front edge 156a of the leg deck board 78a is lower than the rear edge 158a of the leg deck board 78a. This movement of the leg deck board 78a causes or pulls the foot deck board 80a towards the head end 11a of the bed 10a as the foot links 100a are pivoted about horizontal pivot axes in a clockwise direction as viewed in FIG. 7. In its fully inclined position shown in FIG. 7, the front edge 160a of the foot deck board 80 is higher than the rear edge 162a of the foot deck board 80a.

As desired, the adjustable bed 10a may be moved from its fully inclined position shown in FIG. 7 (in which the front edge 154a of the head deck board 74a is above the rear edge 155a of the head deck board 74a) back to its horizontal position shown in FIG. 8 via use of the motorized linear actuator assembly 106a. Regardless of the position of the adjustable bed 10a, the lumbar support assembly 130a may be activated to raise the lumbar plate 148a. For example, FIG. 8 shows the lumbar support subassembly 131a in a raised position when the adjustable bed 10a is in a horizontal position.

Although we have described two preferred embodiments of the invention, we do not intend to be limited except by the scope of the following claims.

1. An adjustable bed comprising:
a stationary base having a pair of opposed side rails, each of said side rails including a channel;
a frame movable relative to said stationary base, said frame including a pair of side assemblies;
rollers rotatably mounted to said side assemblies of said frame and being rotatable in said channels of said side rails of said base;
an articulated deck including a seat deck board secured to said movable frame, a head deck board hingedly secured to said seat deck board, a leg deck board hingedly secured to said seat deck board and a foot deck board hingedly secured to said leg deck board, the head and seat deck boards having cutout portions which combined define an opening in said articulated deck;
first and second pivotal torque tubes, each of said torque tubes extending between side assemblies of said frame and being pivotally secured to brackets secured to side assemblies of said frame;
a pair of leg links of a fixed length, each of said leg links being pivotally secured to said frame at one end and being pivotally secured to brackets secured to said leg deck board at the other end;
at least one actuator for pivoting said torque tubes, said first torque tube being operatively coupled to a pair of operating arms having rollers at the ends therefor for engaging said head deck board to raise the head board and said second torque tube being operatively coupled to a pair of operating arms having rollers at the ends therefor for engaging said leg deck board to raise the leg deck board; and
a lumbar support assembly coupled to said seat deck board for raising and lowering a lumbar plate through said opening in said articulated deck.

2. The adjustable bed of claim 1 wherein said lumbar support assembly comprises a linear actuator;
a pair of lift arms, one of said lift arms being secured to said linear actuator;
a lumbar torque tube extending between said lift arms; and
said lumbar plate extending between said lift arms.

3. The adjustable bed of claim 2 further comprising a vibrator secured to said lumbar plate.

4. An adjustable bed comprising:
a stationary base having a pair of opposed side rails;
a frame movable relative to said stationary base, said frame including a pair of side assemblies;
rollers rotatably mounted to said side assemblies of said frame and being rotatable on said side rails of said base;
an articulated deck comprising a seat deck board secured to said frame, said seat deck board having a generally rectangular cutout portion;
a head deck board hingedly secured to said seat deck board, said head deck board having a generally rectangular cutout portion;
a leg deck board hingedly secured to said seat deck board;
a foot deck board hingedly secured to said leg deck board; and
a linear actuator assembly for moving said head, leg and foot deck boards between a horizontal position and an inclined position and moving said frame relative to said stationary base; and
a lumbar support assembly coupled to said seat deck board for moving a lumbar support plate through an opening defined by said generally rectangular cutout portions of said seat and head deck boards.

5. The adjustable bed of claim 4 wherein said lumbar support assembly comprises a linear actuator;
a pair of lift arms, one of said lift arms being secured to said linear actuator;
a lumbar torque tube extending between said lift arms; and
said lumbar plate extending between said lift arms, said lumbar plate being sized to fit through said opening in said articulated deck.

6. The adjustable bed of claim 5 further comprising a vibrator secured to said lumbar plate.

7. An adjustable bed comprising:
a stationary base having a pair of opposed side rails, each of said side rails including a channel;
a frame movable relative to said stationary base, said frame including a pair of side assemblies;
rollers rotatably mounted to said side assemblies of said frame and being rotatable in said channels of said side rails of said base;
an articulated deck comprising multiple deck boards, one of said deck boards being secured to said frame;
a lumbar support assembly coupled to said seat deck board for raising and lowering a lumbar plate through an opening in said articulated deck, wherein said lumbar support assembly further comprises a linear actuator, a pair of lift arms, one of said lift arms being secured to said linear actuator and a lumbar torque tube extending between said lift arms.

8. The adjustable bed of claim 7 further comprising a vibrator secured to said lumbar plate.

9. The adjustable bed of claim 7 further comprising first and second pivotal torque tubes, each of said torque tubes extending between side assemblies of said frame and being pivotally secured to brackets secured to side assemblies of said frame;
a pair of leg links, each of said leg links being pivotally secured to said frame at one end and being pivotally secured to brackets secured to said leg deck board at the other end;
at least one actuator for pivoting said torque tubes, said first torque tube being operatively coupled to a pair of operating arms having rollers at the ends therefor for engaging a head deck board to raise the head deck board and said second torque tube being operatively coupled to a pair of operating arms having rollers at the ends therefor for engaging a leg deck board to raise the leg deck board.

10. An adjustable bed comprising:
a stationary base having a pair of opposed side rails, each of said side rails including a channel;
a frame secured to said stationary base, said frame including a pair of side assemblies;
an articulated deck including a seat deck board secured to said frame, a head deck board hingedly secured to said seat deck board, a leg deck board hingedly secured to said seat deck board and a foot deck board hingedly secured to said leg deck board, the head and seat deck boards having generally rectangular cutout portions which when combined define a generally rectangular opening in said articulated deck;
first and second pivotal torque tubes, each of said torque tubes extending between side assemblies of said frame;
a pair of leg links, each of said leg links being pivotally secured to said frame at one end and being pivotally secured to brackets secured to said leg deck board at the other end;
at least one actuator for pivoting said torque tubes, said first torque tube being operatively coupled to a pair of operating arms having rollers at the ends therefor for engaging said head deck board to raise the head board and said second torque tube being operatively coupled to a pair of operating arms having rollers at the ends therefor for engaging said leg deck board to raise the leg deck board; and
a lumbar support assembly coupled to said seat deck board for raising and lowering a lumbar plate through said opening in said articulated deck.

11. The adjustable bed of claim 10 wherein said lumbar support assembly comprises a linear actuator;
a pair of lift arms, one of said lift arms being secured to said linear actuator;
a lumbar torque tube extending between said lift arms; and
said lumbar plate extending between said lift arms.

12. The adjustable bed of claim 11 further comprising a vibrator secured to said lumbar plate.

13. A motorized lumbar support assembly for use in combination with an adjustable bed having an articulated deck, said lumbar support assembly comprising:
a linear actuator supported by said articulated deck;
a pair of lift arms, one of said lift arms being coupled to said linear actuator;
a torque tube extending between the lift arms;
a lumbar plate extending between the lift arms wherein said lumbar plate may be moved by actuation of said linear actuator between a raised position in which said lumbar plate is above the articulated deck and a lowered position in which said lumbar plate is below the articulated deck.

14. The motorized lumbar support assembly of claim 13 further comprising a vibrator secured to said lumbar plate.

15. An adjustable bed comprising:
an articulated deck comprising a seat deck board secured to a frame, said seat deck board having a generally rectangular cutout portion;
a head deck board hingedly secured to said seat deck board, said head deck board having a generally rectangular cutout portion;
a leg deck board hingedly secured to said seat deck board;
a foot deck board hingedly secured to said leg deck board; and
a linear actuator assembly for moving said head, leg and foot deck boards between a horizontal position and an inclined position; and
a lumbar support assembly coupled to said seat deck board for moving a lumbar support plate through an opening defined by said generally rectangular cutout portions of said seat and head deck boards.

16. The adjustable bed of claim 15 wherein said lumbar support assembly comprises a linear actuator;
a pair of lift arms, one of said lift arms being secured to said linear actuator;
a lumbar torque tube extending between said lift arms; and
said lumbar plate extending between said lift arms, said lumbar plate being sized to fit through said opening in said articulated deck.

17. The adjustable bed of claim 15 further comprising a vibrator secured to said lumbar plate.
